(19) United States
(12) Patent Application Publication
(10) Pub. No.: US 2017/0263947 A1
(43) Pub. Date: Sep. 14, 2017

(54) Lithium-Iron(II) Disulfide Battery and Process for Preparing the Same

(71) Applicant: EVE ENERGY CO., LTD., Huizhou City (CN)

(72) Inventors: Yuan ZHU, Huizhou City (CN); Yanbin WANG, Huizhou City (CN); Chen CHENG, Huizhou City (CN); Rongbin LIANG, Huizhou City (CN); Jianhua LIU, Huizhou City (CN); Jincheng LIU, Huizhou City (CN)

(21) Appl. No.: 15/129,334

(22) PCT Filed: Mar. 31, 2016
(86) PCT No.: PCT/CN2016/078127

§ 371 Date: Sep. 26, 2016

(30) Foreign Application Priority Data
Aug. 21, 2015 (CN) 201510520750.6

(51) Int. Cl. H01M 6/16; H01M 2/18; H01M 2/02

(52) U.S. Cl. CPC H01M 6/162; H01M 2/022; H01M 2/18

(57) ABSTRACT

Disclosed are a lithium-iron(II) disulfide battery and a process for preparing the same. The batter includes a shell, a cap, electrolyte and a cell. The shell is connected with the cap to form a closed cavity in which the electrolyte and cell are accommodated; the cell includes a positive electrode ring, a separator, a spacer, a negative electrode lithium sheet, a current collector grid and a steel strip. The negative electrode lithium sheet is set in the positive electrode ring; the negative electrode lithium sheet is separated from the positive electrode ring by the separator; one side of the current collector grid is connected with the negative electrode lithium sheet, and the other side is connected with the cap via the steel strip; the spacer is set between the positive electrode ring and the cap.

### TECHNICAL FIELD The present invention relates to the technical field of batteries, especially to a lithium-iron(II) disulfide battery and a process for preparing the same.

### BACKGROUND ART

Lithium-iron(II) disulfide batteries are novel green environmental-friendly primary lithium batteries having a nominal voltage of 1.5V, and can be used interchangeably with alkaline manganese batteries, NI—MH batteries, and nickel-cadmium batteries. They have the advantages of stable discharging voltage platform, long storage life and better safety performance.

The winding AA-type lithium-iron(II) disulfide battery 10 prepared according to conventional technology has the structure as shown in FIG. 1, and the production process of such lithium-iron(II) disulfide battery is shown in FIG. 2.

1. Using iron(II) disulfide as positive electrode active substance for positive electrode pole pieces, adding conductive graphite, graphite and adhesive polyvinylidene fluoride, after stirring in a solvent N,N-dimethylpyrrolidone, homogeneously coating on a current collector aluminum foil, drying, pressing and off-cutting to prepare a positive electrode pole pieces of iron(II) disulfide; negative electrode pole pieces are metal lithium and lithium alloys, including pure lithium metal band, lithium-aluminum alloy band, lithium-magnesium alloy band, lithium-boron alloy band as the negative electrode pole pieces of lithium-iron(II) disulfide batteries.

2. Coating a sizing agent onto the current collector, oven-drying and cutting into small pieces, spot welding electrode lug to make positive electrode pole pieces, winding the positive electrode pole pieces with electrode lug, the negative electrode pole pieces and separator into a core 12 of the winding AA-type lithium-iron(II) disulfide battery 10.

3. Placing the core 12 into a steel shell 14, spot-welding on bottom, groove rolling, injecting into the steel shell an organic electrolyte in which lithium iodide is electrolyte salt, spot-covering and sealing to prepare the winding AA-type lithium-iron(II) disulfide battery 10 shown in FIG. 1.

Since the separator and current collector in the battery occupy 15% vol. of the internal cavity of the steel shell, the winding AA-type lithium-iron(II) disulfide battery 10 prepared by the aforesaid preparation process has a capacity of only 3 Ah, and has the defect of small capacity.

### DISCLOSURE OF THE INVENTION

The object of the present invention is to overcome the insufficiencies of the prior art and to provide a lithium-iron(II) disulfide battery having a high capacity, as well as a process for preparing the same.

The object of the present invention is achieved by the following technical solutions.

A lithium-iron(II) disulfide battery comprises a shell, a cap, electrolyte and a cell, wherein the shell is connected with the cap to form a closed cavity in which the electrolyte and cell are accommodated;

wherein the cell comprises a positive electrode ring, a separator, a spacer, a negative electrode lithium sheet, a current collector grid and a steel strip, wherein the negative electrode lithium sheet is set in the positive electrode ring; the negative electrode lithium sheet is separated from the positive electrode ring by the separator; one side of the current collector grid is connected with the negative electrode lithium sheet, and the other side is connected with the cap via the steel strip; the spacer is set between the positive electrode ring and the cap.

Preferably, the external diameter of the spacer is greater than the external diameter of the positive electrode ring, but less than the inner diameter of the shell.

Preferably, the shell has a cylindrical structure; and the positive electrode ring has a circular structure.

Preferably, the negative lithium sheet is in a cylindrical shape; and the spacer is in an annular sheet shape.

Preferably, the shell is made of stainless steel or nickel-plated carbon steel.

Preferably, the positive electrode ring is one or more selected from the group consisting of iron(II) disulfide, graphite, acetylene black and conductive carbon black.

Preferably, the separator is a PP monolayer, a PE monolayer or a combined three-layer of PP, PE and PP.

Preferably, the spacer is made of PP or PE.

Preferably, the negative electrode lithium sheet is pure lithium or lithium alloys.

Preferably, the electrolyte is a solution formed by dissolving lithium salts in PC and 1,3-dioxolane solvents.

Preferably, the current collector grid is made of steel, nickel or aluminum.

A process for preparing lithium-iron(II) disulfide batteries, comprising
step S10: baking active substances: iron(II) disulfide and graphite in positive electrode materials;
step S20: adding active substances: iron(II) disulfide and graphite in a predetermined ratio into a ball-milling tank, and homogeneously stirring under predetermined conditions;
step S30: adding an adhesive into the iron(II) disulfide and graphite which are homogeneously stirred, and then homogeneously stirring the materials;
step S40: making the stirred materials into a positive electrode ring having the same size by a mold, then drying the positive electrode ring at a predetermined temperature;
step S50: placing the positive electrode ring into a shell;
step S60: placing a separator into the positive electrode ring;
step S70: inserting a negative electrode lithium sheet into the positive electrode ring;
step S80: inserting a current collector grid into the negative electrode lithium sheet;
step S90: setting a spacer into the positive electrode ring;
step S100: welding a steel strip and the current collector grid;
step S110: injecting electrolyte into the shell;
step S120: welding the steel strip onto a cap; and
step S130: laminating the cap onto the shell and sealing.

Preferably, in step S10, the active substances: iron(II) disulfide and graphite need to be baked for 4h-8h in a nitrogen or argon atmosphere at a temperature of 80° C.-300° C., and are fed into step S20 after the temperature is decreased to 30° C. -40° C.

Preferably, in step S20, the active substances: iron(II) disulfide having a mass ratio of 85%-96% and graphite having a mass ratio of 5%-8% are added into a low-temperature ball-milling tank, and ball-milled for 2 h under nitrogen protection.

Preferably, in step S30, the adhesive is one or more selected from the group consisting of solvents ethanol, N,N-dimethylpyrrolidone and polytetrafluoroethylene emulsion.

Preferably, in step S40, the prepared positive electrode ring needs to be baked for 4 h-8 h in a nitrogen or argon atmosphere at 80° C.-300° C.

By using the aforesaid lithium-iron(II) disulfide batteries, it can increase the usage amounts of active substance: iron(II) disulfide and negative electrode lithium sheet, and reduce the usage amounts of the separator and current collector. Such structural design can apparently increase the capacity of single cell. As compared with alkaline batteries, the capacity advantage is more apparent. According to the structural design of the present invention, the capacity of lithium-iron(II) disulfide battery may be increased to 4 Ah, greater than about 33.3%.

### DESCRIPTION OF THE DRAWINGS

FIG. 1 shows a structural schematic diagram of a conventional winding lithium-iron(II) disulfide battery.

FIG. 2 shows a production flow chart of the winding lithium-iron(II) disulfide battery shown in FIG. 1.

FIG. 3 shows a structural schematic diagram of a lithium-iron(II) disulfide battery in one example of the present invention.

FIG. 4 shows a production flow chart of a lithium-iron(II) disulfide battery in one example of the present invention.

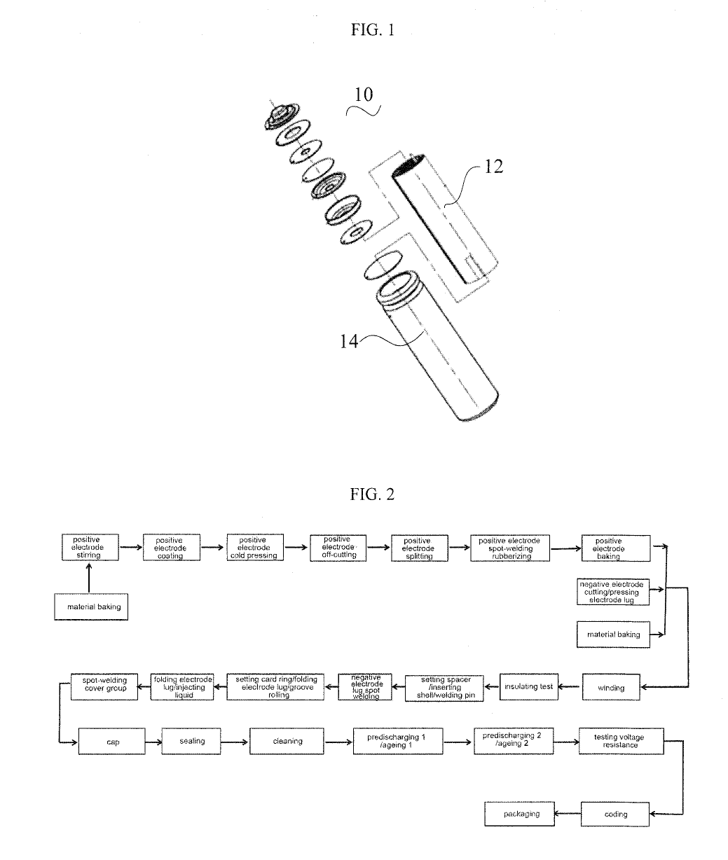

### EMBODIMENTS

The present invention is further and detailedly described by combining with the examples and the drawings, but the embodiments of the present invention are not limited thereby.

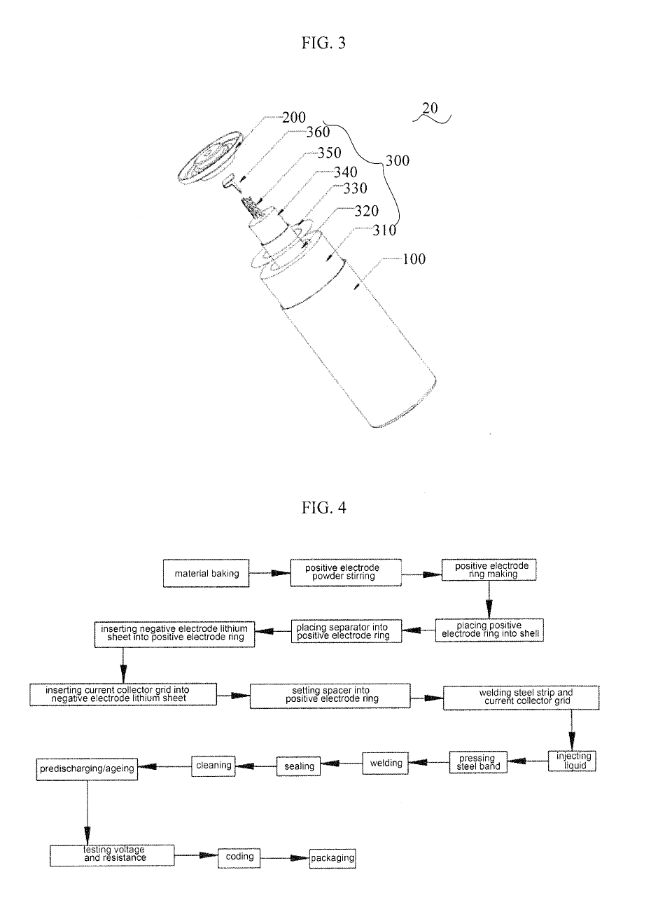

FIG. 3 shows a structural schematic diagram of a lithium-iron(II) disulfide battery 20 in one example of the present invention.

A lithium-iron(II) disulfide battery 20 comprises: a shell 100, a cap 200, electrolyte (not shown) and a cell 300, wherein the shell 100 is connected with the cap 200 to form a closed cavity in which the electrolyte and cell 300 are accommodated.

The cell 300 comprises a positive electrode ring 310, a separator 320, a spacer 330, a negative electrode lithium sheet 340, a current collector grid 350 and a steel strip 360, wherein the negative electrode lithium sheet 340 is set in the positive electrode ring 310; the negative electrode lithium sheet 340 is separated from the positive electrode ring 310 by the separator 320; one side of the current collector grid 350 is connected with the negative electrode lithium sheet 340, and the other side is connected with the cap 200 via the steel strip 360; the spacer 330 is set between the positive electrode ring 310 and the cap 200.

Furthermore, the external diameter of the spacer 330 is greater than the external diameter of the positive electrode ring 310, but less than the inner diameter of the shell 100. The spacer of such size can avoid the contact between the positive electrode ring 310 and the cap 200 and avoid short circuit.

In this example, the shell 100 has a cylindrical structure, and the positive electrode ring 310 has a circular structure. The negative lithium sheet 340 is in a cylindrical shape, and the spacer 330 is in an annular sheet shape. In other examples, the shell 100 may also has a square structure, or a polygonal cylindrical structure, but is not limited thereby.

It should be noted that the shell 100 is made of stainless steel or nickel-plated carbon steel; the positive electrode ring 310 is one or more selected from the group consisting of iron(II) disulfide, graphite, acetylene black and conductive carbon black; the separator 320 is a PP monolayer, a PE monolayer or a combined three-layer of PP, PE and PP; the spacer 330 is made of PP or PE; the negative electrode lithium sheet 340 is pure lithium or lithium alloys; the electrolyte is a solution formed by dissolving lithium salts in PC and 1,3-dioxolane solvents; and the current collector grid 350 is made of steel, nickel or aluminum.

FIG. 4 shows a production flow chart of a lithium-iron(II) disulfide battery in one example of the present invention.

Corresponding to the aforesaid lithium-iron(II) disulfide battery 20, the present invention further provides a process for preparing lithium-iron(II) disulfide batteries, primarily comprising the following steps:
step S10: baking active substances: iron(II) disulfide and graphite in positive electrode materials;
step S20: adding active substances: iron(II) disulfide and graphite in a predetermined ratio into a ball-milling tank, and homogeneously stirring under predetermined conditions;
step S30: adding an adhesive into the iron(II) disulfide and graphite which are homogeneously stirred, and homogeneously stirring the materials;
step S40: making the stirred materials into a positive electrode ring having the same size by a mold, then drying the positive electrode ring at a predetermined temperature;
step S50: placing the positive electrode ring into a shell;

1step S60: placing a separator into the positive electrode ring;
step S70: inserting a negative electrode lithium sheet into the positive electrode ring;
step S80: inserting a current collector grid into the negative electrode lithium sheet;
step S90: setting a spacer into the positive electrode ring;
step S100: welding a steel strip and the current collector grid;
step S110: injecting electrolyte into the shell;
step S120: welding the steel strip onto a cap; and
step S130: laminating the cap onto the shell and sealing.

Wherein, in step S10, the active substances: iron(II) disulfide and graphite need to be baked for 4 h-8 h in a nitrogen or argon atmosphere at a temperature of 80° C.-300° C., and are fed into step S20 after the temperature is decreased to 30° C.-40° C. In other examples, the positive electrode materials baked in step S10 are one or more selected from the group consisting of iron(II) disulfide, graphite, conductive carbon black and acetylene black.

Wherein, in step S20, the active substances: iron(II) disulfide having a mass ratio of 85%-96% and graphite having a mass ratio of 5%-8% are added into a low-temperature ball-milling tank, and ball-milled for 2 h under nitrogen protection.

Wherein, in step S30, the adhesive is one or more selected from the group consisting of solvents ethanol, N,N-dimethylpyrrolidone and polytetrafluoroethylene emulsion.

Preferably, in step S40, the prepared positive electrode ring needs to be baked for 4 h-8 h in a nitrogen or argon atmosphere at 80° C.-300° C.

It should be stated that, in step S40, the positive electrode ring is obtained by molding positive electrode materials homogeneously stirred in a mold. The external diameter of the molded positive electrode ring is slightly less than the internal diameter of the shell, so as to readily place the positive electrode ring into the shell. During the following ageing process, the battery cell will expand, and the positive electrode ring will be in contact with the shell so as to form interference fit. Therefore, the shell will become the positive electrode of the battery. Such process is not only convenient to the production of the batteries, but also can improve the battery quality.

It shall be especially noticed that, after placing the positive electrode ring into the shell, wrinkles shall not appear on the separator while placing the separator into the positive electrode ring, to ensure that the part in contact with the positive electrode ring shows a single layer state. While inserting the current collector grid into the negative electrode lithium sheet, the current collector grid shall not scrape the separator.

By using the aforesaid lithium-iron(II) disulfide battery 20, it can increase the usage amounts of active substance: iron(II) disulfide and negative electrode lithium sheet, and reduce the usage amounts of the separator and current collector. Such structural design can apparently increase the capacity of single cell. As compared with alkaline batteries, the capacity advantage is more apparent. According to the structural design of the present invention, the capacity of lithium-iron(II) disulfide battery 20 may be increased to 4 Ah, greater than about 33.3%.

The aforesaid examples are preferred embodiments of the present invention, but the embodiments of the present invention are not limited by the aforesaid examples. Any other changes, modifications, replacements, combinations, or simplifications which do not depart from the spirit and principle of the present invention will be deemed as equivalent substitutions, and will be comprised within the protection scope of the present invention.

1-10. (canceled).

11. A lithium-iron(II) disulfide battery, comprising:
a shell;
a cap;
an electrolyte; and
a cell,
wherein the shell is connected with the cap to form a closed cavity in which the electrolyte and the cell are accommodated; wherein the cell comprises a positive electrode ring, a separator, a spacer, a negative electrode lithium sheet, a current collector grid and a steel strip, wherein the negative electrode lithium sheet is set in the positive electrode ring; the negative electrode lithium sheet is separated from the positive electrode ring by the separator; one side of the current collector grid is connected with the negative electrode lithium sheet, and the other side of the current collector grid is connected with the cap via the steel strip; the spacer is set between the positive electrode ring and the cap.

12. The battery according to claim 11, wherein an external diameter of the spacer is greater than an external diameter of the positive electrode ring, but less than an inner diameter of the shell.

13. The battery according to claim 11, wherein the shell has a cylindrical structure and the positive electrode ring has a circular structure.

14. The battery according to claim 11, wherein the negative lithium sheet is in a cylindrical shape and the spacer is in an annular sheet shape.

15. The battery according to claim 11, wherein the shell is made of stainless steel or nickel-plated carbon steel;
the positive electrode ring is one or more selected from the group consisting of iron(II) disulfide, graphite, acetylene black and conductive carbon black;
the separator is a PP monolayer, a PE monolayer or a combined three-layer of PP, PE and PP;
the spacer is made of PP or PE;
the negative electrode lithium sheet is pure lithium or lithium alloys;
the electrolyte is a solution formed by dissolving lithium salts in PC and 1,3-dioxolane solvents; and
the current collector grid is made of steel, nickel or aluminum.

16. A process for preparing a lithium-iron(II) disulfide battery, comprising:
step S10: baking active substances: iron(II) disulfide and graphite in positive electrode materials;
step S20: adding active substances: iron(II) disulfide and graphite in a predetermined ratio into a ball-milling tank, and homogeneously stirring under predetermined conditions;
step S30: adding an adhesive into the iron(II) disulfide and graphite which are homogeneously stirred, and homogeneously stirring the materials;
step S40: making the stirred materials into a positive electrode ring having the same size by a mold, then drying the positive electrode ring at a predetermined temperature;
step S50: placing the positive electrode ring into a shell;
step S60: placing a separator into the positive electrode ring;
step S70: inserting a negative electrode lithium sheet into the positive electrode ring;
step S80: inserting a current collector grid into the negative electrode lithium sheet;
step S90: setting a spacer into the positive electrode ring;
step S100: welding a steel strip and the current collector grid;
step S110: injecting electrolyte into the shell;
step S120: welding the steel strip onto a cap; and
step S130: laminating the cap onto the shell and sealing.

17. The process according to claim 16, wherein in step S10, the active substances: iron(II) disulfide and graphite need to be baked for 4 h-8h in a nitrogen or argon atmosphere at a temperature of 80° C.-300° C., and are fed into step S20 after the temperature is decreased to 30° C.-40° C.

18. The process according to claim 16, wherein in step S20, the active substances: iron(II) disulfide having a mass ratio of 85%-96% and graphite having a mass ratio of 5%-8% are added into a low-temperature ball-milling tank, and ball-milled for 2 h under nitrogen protection.

19. The process according to claim 16, wherein in step S30, the adhesive is one or more selected from the group consisting of solvents ethanol, N,N-dimethylpyrrolidone and polytetrafluoroethylene emulsion.

20. The process according to claim 16, wherein in step S40, the prepared positive electrode ring needs to be baked for 4 h-8 h in a nitrogen or argon atmosphere at 80° C.-300° C.
